(19) United States
(12) Patent Application Publication
(10) Pub. No.: US 2024/0289918 A1
(43) Pub. Date: Aug. 29, 2024

(54) REPRESENTATIVE MODIFIED IMAGES

(71) Applicant: Ford Global Technologies, LLC, Dearborn, MI (US)

(72) Inventors: Surya Gandikota, Richmond, TX (US); Vikas Rajendra, Novi, MI (US)

(73) Assignee: Ford Global Technologies, LLC, Dearborn, MI (US)

(21) Appl. No.: 18/175,614

(22) Filed: Feb. 28, 2023

(51) Int. Cl. G06T 3/40; G06F 3/14; G06T 3/60; G06T 5/00; G06V 10/60

(52) U.S. Cl. CPC G06T 3/40; G06F 3/14; G06T 3/60; G06T 5/70; G06V 10/60; G06T 2207/10024; G06T 2207/30252

(57) ABSTRACT

Generating modified image representations may utilize a system, which includes a computer having a processor coupled to a memory, the memory including instructions executable by the processor, to obtain user input of parameters to direct probabilities of modification types for a base image stored in a database, and to generate, responsive to the user input, a representation of the base image that includes modifications according to the parameters. The processor coupled to the memory may additionally direct the computer to transmit the representation of the base image to a second computer for display.

### BACKGROUND

Visual images can be acquired by a camera and processed using a computer to determine parameters with respect to objects within the field-of-view of the camera. In some instances, a computer vision application may process an image utilizing a neural network that has been trained to recognize whether an acquired image meets predetermined criteria. In some instances, training of a neural network may involve transmission of a large number of acquired images to the computer so that the computer vision application can develop a capability to accurately identify whether objects in the images meet the predetermined criteria.

### BRIEF DESCRIPTION OF THE DRAWINGS

FIG. 1 is a diagram of a vehicle undergoing inspection via a computer vision application in a manufacturing process.

FIG. 2 is a diagram of an example training operation for a computer vision application .

FIG. 3 is a diagram of an example user interface for generating modified image representations.

FIGS. 4-5 are flowchart diagrams of example processes for generating modified image representations.

### DETAILED DESCRIPTION

Advantageously, techniques described herein can bring about a significant reduction in the time consumed to determine whether a high-resolution is acceptable for training a computer vision application. In example embodiments, base images and images modified for computer vision application training purposes, typically have relatively large file sizes and would consume significant bandwidth if transmitted over a user network to the user computer. Thus, it is advantageous to transmit a representation of a modified image, having a reduced file size, so as to enable a determination as to whether a corresponding high-resolution image would be acceptable in the computer vision training environment. An illustrative environment for implementing present techniques of generating and providing modified image representations of base images is training a computer vision system, e.g., for a manufacturing environment. A modified image representation may be provided to a user computer to allow a user to evaluate whether an image from a manufacturing environment represented by modified image representations are to be selected for a computer vision application training process. In example embodiments, during a training process, a server computer, for example, may be programmed to expeditiously generate modified image representations for transmission to a human user at a user computer such as a remote computer workstation. In some instances, a modified image representation may include a down-sampled version of a modified image utilized in training a computer vision application. However, in the context of this disclosure, a modified image representation refers to any image generated by a technique that operates to reduce the file size of a base image. Thus, a modified image representation may refer to a down-sampled base image, but may also refer to an image that has been rendered utilizing fewer colors than are utilized to depict a base image, a lossy-compressed version of a modified image, etc.

Continuing the example implementation of a manufacturing environment system, a down-sampled representation of a modified image may thus be rapidly evaluated by the user to determine whether to select the modified image for training the computer vision application. Alternatively or in addition to selecting the modified image, the user may select parameters to specify different modifications of the base image and convey the parameters to the server computer. The server computer may then generate representations of the differently modified base images for transmission to the user; advantageously, such transmission may be achieved more efficiently, e.g., consuming less bandwidth and/or time, than would be required for transmission of a high-resolution modified base image itself.

Approaches toward implementing computer vision techniques, or image recognition, can be implemented in a variety of environments and/or applications, and can be advantageous in any system with a large number of and/or large image files are to be presented via a user's display device. For example, a large number of images, e.g., thousands, tens of thousands, or more, may be used to train a computer vision application. As mentioned above, an illustrative example computer vision system could be one trained to determine whether a manufactured item meets a predetermined set of criteria. For example, in a vehicle manufacturing environment, a computer vision application may be utilized to detect whether various components and/or assemblies of the vehicle are properly installed. In such examples, for a computer vision application to recognize improperly installed vehicle components and/or assemblies, the computer vision application may be trained so as to distinguish a properly installed vehicle component and/or assembly from a vehicle component and/or assembly that requires rework and/or replacement. Such distinguishing of properly installed vehicle components and/or assemblies from improperly installed vehicle components and/or assemblies may take place under a variety of environmental conditions, such as under bright lights versus normal lighting, at various camera angles, at various camera orientations, various camera aspect ratios, and/or with component elements being in focus while other component elements may be out of focus.

In some examples, training a computer vision application for use in a manufacturing environment may begin by training the application to recognize properly versus improperly fabricated and/or installed vehicle components utilizing an image acquired by a camera that is positioned normally (i.e., directly in front of) with respect to the vehicle component and under nominal lighting conditions. For example, an initial or base image of a vehicle windshield may include an image acquired by a camera positioned directly above the windshield under ideal lighting conditions. In response to the computer vision application correctly identifying a properly installed windshield utilizing an image acquired under such conditions, the base image may then be modified, such as being re-colored, blurred, acquired under different lighting conditions, rotated or tilted in a particular direction, and so forth. Images indicating such modifications may then be inputted to the computer vision application so as to train the application to recognize a properly installed component under differing conditions. In response to training the computer vision application to recognize properly installed vehicle components utilizing numerous modified images, the application may be trained to operate in a wide variety of manufacturing environments. In some instances, training a computer vision application may include input of thousands, or even tens of thousands, of images to a computer vision application so as to train the application to encounter a full complement of possible variations in the parameters of acquired images. By way of such training, the computer vision application may be capable of distinguishing improperly fabricated and/or installed components from properly installed components in a real-world manufacturing environment.

In a supervised training process of a computer vision application, a human user may evaluate whether the application has accurately recognized a particular properly versus improperly installed vehicle component, for example. A supervised training process may involve a user attending to a user interface to review numerous images and determining whether the application has correctly distinguished between properly installed vehicle components and improperly installed vehicle components. However, in some instances, prior to submittal of modified images in connection with a computer vision application training process, a human user may wish to determine whether the modified images are likely to be of value in the training process. For example, when training such an application, overly darkened images or images that are excessively blurred may not be representative of a target manufacturing environment. Thus, such modified images may be of low training value for the computer vision application. Moreover, responsive to base and modified images comprising images of relatively high resolution, which may be transmitted from a server to a remote user's display device via a communications network, merely evaluating a set of images for suitability in a computer vision application training process may itself be a time-consuming and tedious process.

Exemplary embodiments may include a system, which may be utilized in generating representative modified base images, may include a first computer having a processor coupled to a memory, in which the memory includes instructions executable by the processor to obtain input of user-selectable parameters to direct probabilities of modification types of a base image stored in a database and to generate, responsive to signals indicating the user input, a representation of the base image that includes modifications according to the parameters. The instructions executable by the processor may additionally operate to transmit the representation of the base image to a second computer for display.

The input parameters can include directions to rotate the base image in a horizontal plane of the base image, to rotate the base image in a vertical plane of the base image, to modify contrast between portions of the base image, to modify brightness of a portion of the base image, to modify visual noise content of a portion of the base image, and/or to add blur to a portion of the base image.

The representation of the modified base image can correspond to a down-sampled modified representation of the base image.

The input parameters may include a selection of a number of representations of the base image to be transmitted to the second computer for display.

The representation of the modified base image can correspond to a down-sampled modified representation of the base image, wherein the modified representation is down-sampled by a user-selectable amount.

The representation of the modified base image can be transmitted in a JavaScript Object Notation (JSON) format.

The modified base image can include an array of red-green-blue (RGB) values.

The representation of the modified base image can correspond to a down-sampled modified representation of the base image. In addition, the instructions executable by the processor may include instructions to obtain a down sampling value to be applied to the modified base image.

The transmission of the representation of the base image can be substantially simultaneous with generation of the modified base image.

Prior to obtaining the user input parameters, the first computer may transmit the base image to the second computer for display.

A method, which may be utilized to generate modified image representations can include obtaining, from a first computer including a processor coupled to a memory, a user input of parameters for directing probabilities modification types of the base image stored in a database and generating, responsive to the user input, a representation of the base image that includes modifications according to the parameters. The method may additionally include transmitting the representation of the base image to a second computer for display.

The input parameters can comprise a selectable number of representations of the base image to be transmitted to the second computer for display.

The input parameters can comprise directions to rotate the base image in a horizontal plane of the base image, to rotate the base image in a vertical plane of the base image, to modify contrast between portions of the base image, to modify brightness of a portion of the base image; to modify visual noise content of a portion of the base image, and/or to add blur to a portion of the base image.

The representation of the modified base image can correspond to a down-sampled modified representation of the base image.

The representation of the modified base image can correspond to a compressed modified representation of the base image.

The method can further include obtaining a user input of a parameter indicating a down sampling amount of the representation of the modified base image.

The method can further include transmitting the representation of the base image can be performed substantially simultaneously with generating the modified base image.

The method may further include transmitting, to the second computer, the base image for display.

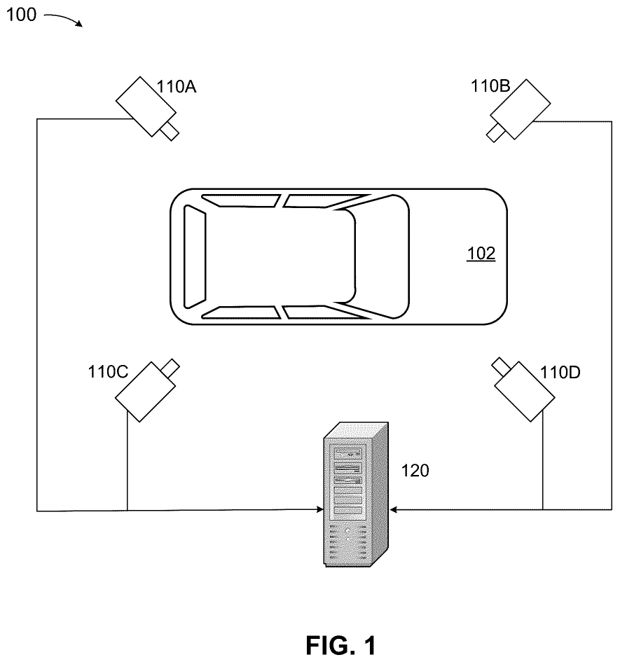

FIG. 1 is a diagram 100 of a vehicle undergoing inspection via a computer vision application in a manufacturing process. In FIG. 1, vehicle 102 may, for example, represent an automobile undergoing a final inspection involving cameras 110A, 110B, 110C, and 110D, each of which may acquire an image of an aspect of the vehicle. Cameras 110A, 110B, 110C, and 110D may acquire images to be utilized by server 120 to detect proper fabrication, workmanship, painting and sealing, installation of one or more panels of vehicle 102, installation of rims and/or tires of vehicle 102, or any other aspect visible via external inspection of the vehicle. Images acquired by cameras 110A, 110B, 110C, and 110D may be transmitted to server 120, which can implement a computer vision application that has been trained to distinguish any number of visible flaws. Thus, server 120 may execute a computer vision application, which utilizes images acquired by cameras 110A, 110B, 110C, and 110D and, based on such acquired images, transmits messages to indicate whether any one of numerous manufacturing defects have been observed. In example embodiments, the computer vision application executing via server 120 has been trained to recognize such manufacturing defects in a variety of vehicle similar to vehicle 102, under a variety of lighting environments, utilizing a variety of camera angles, etc.

### Exemplary System Operations

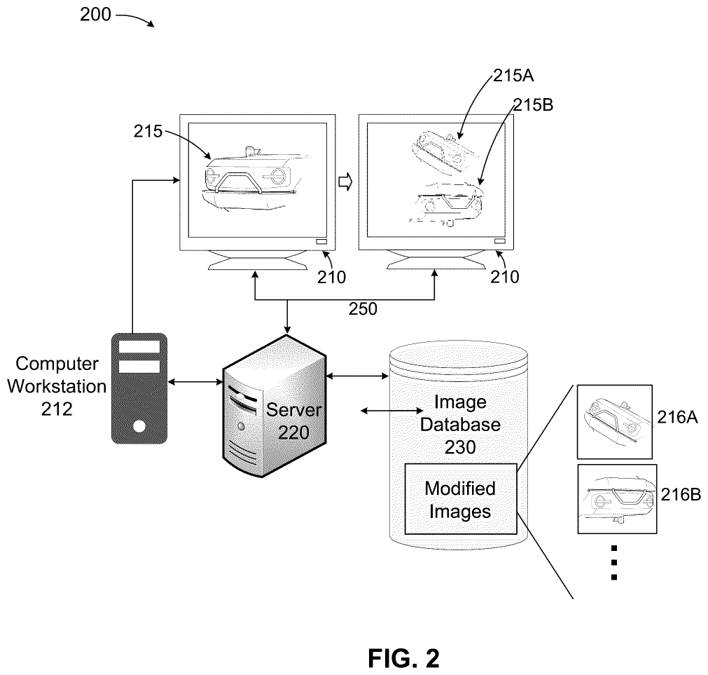

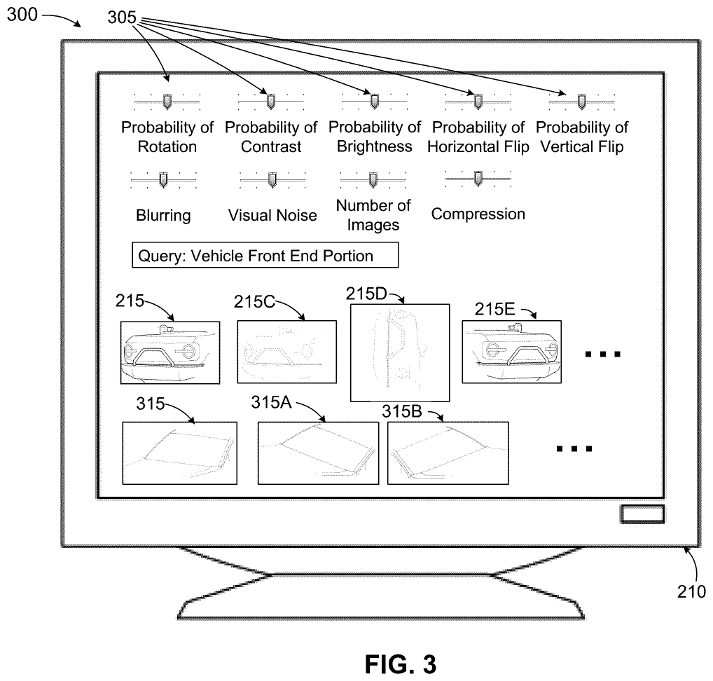

FIG. 2 is a diagram of an example system 200 for conducting a training operation for a computer vision application. As depicted in FIG. 2, a user may interact with computer workstation 212 to select training images for the computer vision application. In the example of FIG. 2, a user has selected base image 215, which can correspond to a front portion of a vehicle as a base image for modification during the training process. However, it should be understood that base image 215 can correspond to any base image acquired and provided for selection for purposes other than training of a computer vision application for use in a manufacturing environment, e.g., images 215 could be provided for selection of images for training other computer vision applications or for any application where it is desired to display lower resolution images for providing image selections and/or manipulations to a server. Accordingly, base image 215 could correspond to a pedestrian walking along a roadway, a signpost, or a natural object, such as may be useful in a vehicle on board object recognition and driver assistance application. In another example, base image 215 could correspond to an image of a radiograph showing a fractured bone or an acquired image of a skin lesion, such as may be encountered in a healthcare environment. Moreover, as discussed further below with respect to FIG. 3, in an exemplary implementation, a user can request a category of base images 215, such as any of the above, whereupon a plurality of base images 215, and corresponding modified images e.g., 215A-215E, 315A-315B (discussed below), may be provided on the display 210.

In this context, a base image may be any image that has been previously uploaded and stored in image database 230 and accessible for display, e.g. via display 210. Thus, for example, base image 215 may be available via the ImageNet project, which includes a large visual image database designed for use in visual object recognition software research and training. In another example, base image 215 may be acquired through any other means, such as by way of accessing a medical training and diagnostics database, accessing an image via the Internet, or accessing an online photo album comprising images captured by individuals, etc. Thus, for example, base image 215 may have been labeled as, for example, “vehicle bumper and grille” by a previously performed process as part of a larger image-cataloging and labeling process. Also in this context, modified image refers to a base image that has been modified in accordance with one or more selectable parameters. In some example embodiments, hundreds, thousands, or an even greater number of modified images may be generated utilizing a single base image 215.

In the example of FIG. 2, signals generated by a user interface in response to the user's interactions with computer workstation 212 may provide selections indicating respective modification parameters such as modification probabilities for a base image 215 or category of base images 215. For example, a user may interact with computer workstation 212 to request images of “vehicle front portion.” Thus, in response to input from a user interface, base image 215 may be modified, e.g., rotated, tilted, darkened, lightened, assigned different colors or hues, blurred, displayed with differing contrasts among various elements, displayed with differing amounts of visual noise, etc. In example embodiments, a user may provide input to perform such modifications to base image 215 by way of a slider bar or the like, where the input specifies a parameter such as a modification probability for respective modifications (such as rotation, brightening or darkening, color contrast, etc.), i.e., a probability that a modified image e.g., 215A, 215B of a base image 215 will have the respective modification, e.g., be rotated, brightened, have different color contrast, etc. The user input of a modification probability may be on a scale ranging from a zero value to a value of 100%, for example. Via selection of a value utilizing a slider bar, server 220 may be directed to generate modified images and to provide to the computer workstation 212 representations thereof, e.g., modified image representations 215A and 215B, where a percentage of the modified image representations have respective modifications corresponding to the selected values indicated via user input providing the modification probabilities. For example, based on a selection of 50% rotation, server 220 may return modified image representations, such as modified image representations 215A and 215B, 50% of which have undergone some amount of rotation of base image 215. In another or the same example, based on a selection of 25% contrast, server 220 may return a collection of images, 25% of which include some amount of varying contrast among elements of base image 215. A user may be able to provide input to generate a specified number of images modified images with modifications of base image 215 according to input modification probabilities. High-resolution modified images 216A and 216B, and potentially dozens, hundreds, or even thousands of high-resolution modified images generated by server 220 may be stored in image database 230 substantially simultaneously with display of modified image representations 215A and 215B via display 210. Modified images, e.g., 216A and 216B, stored in image database 230, may then be utilized to train a computer vision application, executing via server 220, to recognize any number of variations of base image 215, which may be useful in a manufacturing environment. In example embodiments, high-resolution modified images, e.g., 216A and 216B, may be stored in image database 230 without any need to display the modified images via display 210.

In response to selection of various modifications to base image 215, modified image representations may be displayed, e.g., via display 210. It should be noted that although only two modified image representations, e.g., images 215A and 215B, are illustrated in FIG. 2 as displayed via display 210, any suitable number of modified image representations, e.g., 215A, 215B, etc., may be displayed in a gallery view.

In example embodiments, modified image representations 215A and 215B may comprise down-sampled images, such as images displayed with reduced resolution. For example, modified image representations 215A and 215B may include down-sampled images having resolution of between 1% and 15% of modified images 215A and 215B, which may be immediately displayed via display 210. Such down sampling and/or other reduction in file size of modified images may be especially advantageous in instances for which modified images generated by server 220 correspond to high-resolution images, such as images acquired via cameras having, for example, 12 megapixel to 30 megapixel resolution. Following display of modified image representations, actual high-resolution images can be displayed via display 210. However, in response to modified image representations including lower resolution, e.g., 1% resolution, 2% resolution, 5% resolution, 10% resolution, etc., than a resolution of modified images generated by server 220 and stored in image database 230, such images may be rapidly generated by server 220 and transmitted to display 210, thereby reducing bandwidth for transmitting and computer resources for storing and presenting base images 215. Accordingly, in rapid succession, a user may select modifications to a base image, evaluate modified image representations that embody such modifications, and moreover could revise modification parameters, and such revised parameters to server 220 instead of, or in addition to, originally selected parameters. FIG. 3 is a diagram 300 of an example user interface for providing input to generate modified images and for viewing modified representative images. In the diagram of FIG. 3, display 210 shows slider bars 305, which permit the user to select modification probabilities that a modified image will include respective modifications. For example, responsive to a user input query a category of images, such as “vehicle front end portion” base image 215, showing a vehicle front end bumper and grille, and base image 315, showing a front view of a vehicle windshield and surrounding structure, along with potentially many other base images, may be displayed via display 210. In an example, responsive to a user selection of a probability of rotation of 50%, a probability of contrast of 50%, a probability of brightness of 50%, a probability of horizontal flip of 50%, and a probability of vertical flip of 50%, then 50% of the returned, modified image representations 215C, 215D, 215E, along with potentially numerous other modified image representations, are generated from base image 215 in which modified image representations will comprise a random amount of each of the selected modifications. Similarly, modified image representations 315A, 315B, and potentially numerous other modified image representations, will be generated from base image 315 in which modified image representations will comprise a random amount of each of the selected modifications. In another example, responsive to a user selection of a probability of rotation of 30%, a probability of contrast of 70%, a probability of brightness of 50%, a probability of horizontal flip of 35%, and a probability of vertical flip of 45%, then, for each of the modified images depicted by the modified image representations 215A-315B, there is a 30% probability of image rotation, a 70% probability of a contrast modification, a 50% possibility of a brightness modification, a 35% probability of a horizontal flip, and a 45% probability of a vertical flip. Thus, some modified image representations may include no modifications or some but less than all of the possible modifications. Some modified images may include all of the modifications. Random amounts of individual selected modifications can be determined, for example, by server 220, using any suitable technique for randomization. As just described, in example embodiments, more than one modification may be applied to an individual image. Thus, in accordance with the preceding example, a particular returned image may be modified by being rotated and, in addition, may be blurred as well as rendered utilizing a different, e.g., randomly assigned, level of contrast than that of base images 215 and 315. An input mechanism such as slider bars 305 may further permit the user to select the number of modified images to be generated, and hence to be displayed as modified image representations and/or a compression ratio for modified image representations, i.e., in amount of compression applied to a modified image stored by the server 220 in the database 230. For example, for training a computer vision application to recognize improperly installed wire harnesses in a vehicle manufacturing environment, a user may select a compression value between 85% and 95%. However, in another example, for training a computer vision application to recognize relatively featureless objects, a user may select a compression value between 90% and 99%.

Server 220 may generate modified image representations 215C, 215D, 215E, 315A, and 315B concurrently with storage of high-resolution corresponding to modified image representations. In example embodiments, server 220 may be directed to return any number of modified image representations, such as hundreds, thousands, or an even greater number of modified image representations, each of which corresponds to a high-resolution modified image generated at server 220. In the diagram of FIG. 3, modified image representation 215C has been rendered utilizing a randomly assigned level of contrast that is less than base image 215. FIG. 3 also shows modified image representation 215D, which has been rendered utilizing a randomly assigned level of contrast that is less than that of base image 215 and has additionally been rotated 90 degrees. Similarly, FIG. 3 shows modified image representation 215E, which has been flipped horizontally and rendered with a randomly assigned level of brightness that is greater than that of base image 215.

Advantageously, the user interface of FIG. 3 may enable generation, review, and/or selection of modified image representations, e.g., 215A-215E, 315A-315B for training a computer vision application for various environments and/or applications. In an example, for training a computer vision application for use in a soft drink bottling facility, in which vertically-oriented containers are conveyed via a conveyor belt and physically restrained from tipping by a harness, it may be highly unlikely that a sealed bottle will become horizontally oriented during the conveying process. Accordingly, a computer vision application designed to detect unsealed containers may be trained without utilizing modified images of a container that has been rotated or flipped. In such an instance, slider bars 305 corresponding to probability of vertical flipping of an image may be set to zero or to a small number. This may allow the computer vision application to be trained utilizing other types of modified images, such as images that are blurry, illuminated with varying levels of brightness, etc.

Thus, advantageously, a user may be provided a capability to rapidly determine whether modified image representations correspond to high-resolution modified images that are useful in training of a computer vision application. In an example, in response to a user selecting that 100% of modified images are to be blurred, display 210 may display images that are determined to be too blurry for use in the training application. Consequently, the user may select to reduce the probability that modified images will be blurred, which may result in server 220 generating new modified images, a lesser number of which exhibit blurring. Modified images exhibiting excessive blur, stored in image database 230, may then be discarded and newly-modified images exhibiting less blur may then be stored in image database 230.

### Example Processes

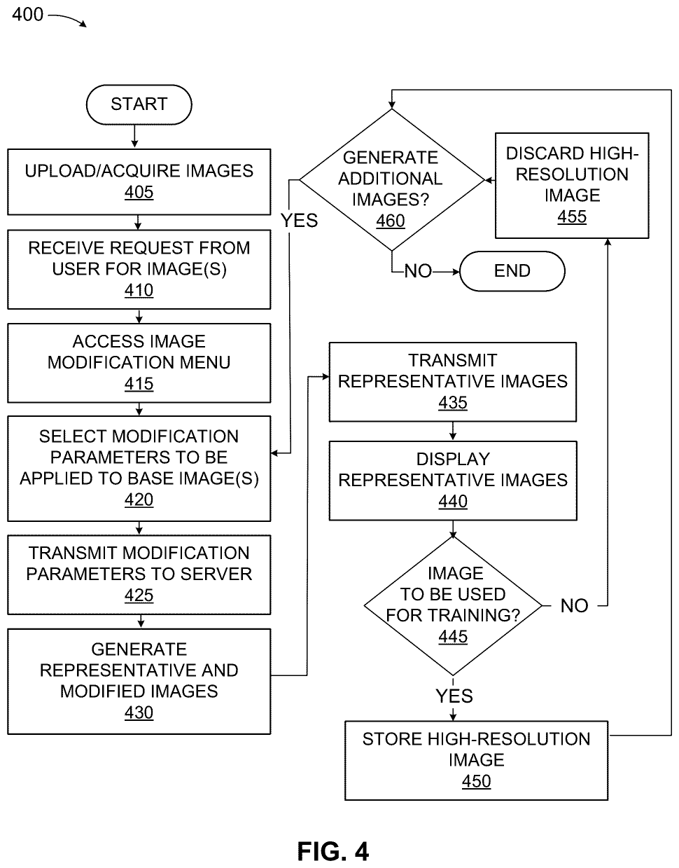

FIG. 4 is a flowchart diagram of an example process 400 for generating modified image representations, such as described in relation to FIGS. 2 and 3. Processes 400 and 500 can be implemented utilizing a first computer, e.g., computer workstation 212, cooperating with a second computer, e.g., server 220. However, processes 400 and 500 could alternatively be implemented utilizing any suitable computer and network architecture, including rearrangement of system elements described in reference to FIG. 2 and/or with a different user interface described in reference to FIG. 3. Process 500 may involve a user interacting with a user interface of computer workstation 212 to view one or more base images, e.g., 215 and 315, and to then provide input selecting one or more parameters, e.g., modification probabilities as described above, for modification of the base image(s). In example embodiments, a server 220, as described above, begins a process to return modified images representations utilizing a selected base image, e.g., 215, 315, along with a set of probabilities for image modification transmitted by computer workstation 212. In response to a user input of a set of modification probabilities, as described above, the server applies one or more of the selected modifications to the base image that accord with the user-selectable probabilities and returns representative, e.g., down-sampled, compressed, etc., modified images. Modified image representations, 215A-215E, 315A-315B, corresponding to modified base images may then be transmitted to computer workstation 212, where a decision may be made as to whether the image represented by the modified image representation is acceptable for training a computer vision application. Responsive to a determination that a modified image representation, e.g., 215A-215E, 315A-315B, is not acceptable for training a computer vision application, e.g., too blurry, too dark, includes an unacceptable level of contrast between portions of the modified image representation, etc., the corresponding high-resolution modified image(s), e.g., 216A, 216B, may be discarded by server 220. Responsive to a determination that the modified image representation, e.g., 215A-215E, 315A-315B, is acceptable for training a computer vision application, server 220 may store the corresponding high-resolution image(s), e.g., 216A, 216B, in database 230. Process 400 includes multiple blocks that can be executed in the illustrated order. Process 400 could alternatively or additionally include fewer blocks or can include the blocks executed in different orders.

Process 400 begins at block 405, at which a base image, e.g., 215, may be uploaded to and stored in image database 230, such as described in reference to FIG. 2. As previously mentioned, base images, e.g., base image 215, may be uploaded utilizing the ImageNET project, available at the time of filing this application at ImageNet.org, which includes a large visual image database designed for use in visual object recognition software research and training. Alternatively or additionally, uploaded base image 215 may be acquired via any other suitable means and/or sources, which may include uploading base images from other databases, photo albums, project files, online libraries, etc.

Process 400 may continue at block 410, at which server 220 may receive a request, e.g., according to a user input provided at computer workstation 212, for a particular base image or base images that meet the request, e.g., a category or other name or label for a set of one or more base images 215 stored in a database 230. For example, to obtain base images for training a computer vision system for use in a manufacturing environment, a user may interact with a user interface of computer workstation 212 to request base images corresponding to a particular portion of a manufactured object, such as “vehicle front end portion.” In other examples, depending on an application, such as a type of computer vision training application for which images are to be provided, a user interface may enable a user to request an image of an object that may be encountered in a traffic environment, such as base images corresponding to “pedestrian walking dog,” an image of a certain type of radiograph depicting an image encountered in a healthcare environment, such as “simple fracture, femur,” etc.

Process 400 may continue at block 415, at which, in response to user input via a user interface, display 210 may present one or more base images 215 in response to a received query, e.g., “vehicle front end portion,” “pedestrian walking dog,” etc.

Process 400 may continue at block 420, at which a user may access a user interface including a menu, e.g., comprising slider bars 305, or the like of computer workstation 212. The menu may display options for applying selected modifications to a base image e.g., base image 215. For example, the menu may display options to specify modification probabilities, e.g., in the form of slider bars 305, corresponding to the types of modifications, e.g., rotation, horizontal flip, vertical flip, altering brightness, adding visual noise and/or visual blur, etc., that may be applied to base image 215. For example, a slider bar 305 displayed on a user interface of computer workstation 212 may permit the user to assign respective modification probabilities according to which each modified image 216A, 216B includes respective modifications. Thus, in an example, responsive to user interface signals specifying that 200 modified images are to be generated utilizing base image 215, in which 100% of the modified images are to include varying levels of brightness and are to be flipped horizontally, server 220 is directed to return modified images 216A, 216B that are both flipped and rendered with levels of brightness varying from the relevant base image 215. In another example, responsive to user input specifying that 100 images are to be returned, in which 100% of returned images are to be modified to include visual blur and 25% of returned images are to be modified to include visual noise, server 220 may be directed to return 100 images, e.g., 216A, 216B, all of which include a randomly assigned level of visual blurring, and 25% of which are to include a randomly assigned level of visual noise.

Process 400 may continue at block 420, at which a user interface receive input of modification probabilities for one or more of base images, e.g., 215, 315, and/or any other base images returned in response to the user request of the block 410.

Process 400 may continue at block 425, at which the workstation 212 transmits the modification probabilities received according to user input in the block 420 to server 220 utilizing any suitable communications network, such as communications network 250.

Process 400 may continue at block 430, at which server 220 can generate high-resolution modified images e.g., 216A, 216B, in accordance with the modification probabilities received as described with respect to the block 425. Generation of high-resolution modified images may be followed by, or substantially concurrent with, generation of modified image representations e.g., 215A-215E, 315A-315B, for rapid and/or immediate (i.e., as soon as physically possible) transmission to computer workstation 212, e.g., by executing a script or other set of commands. In example embodiments, at block 430, e.g., in response to receiving modification probabilities for a base image 215 from computer workstation 212, server 220 may execute a process to generate modified image representations, e.g., modified image representations 215A-215E, 315A-315B, from generated high-resolution modified images, e.g., 216A, 216B. In example embodiments, server 220 may execute instructions to down sample, compress, or otherwise reduce a file size of, a modified image, e.g., according to user input provided to the workstation 212 as described above and then transmitted to the server 220 along with the modification probabilities. For example, responsive to user input indicating a modified image, e.g., modified image 216A, 216B is to be down-sampled by 90%, to form modified image representations, e.g., 215A-215E, 315A-315B that comprises a file size that is 1/10 the size of a modified image, computer-executable instructions may direct server 220 to scan pixel values in rows of the modified image and to store every 10th pixel value into a separate image file. In another example, responsive to user input indicating that a modified image is to be down-sampled by 95%, server 220 may be directed to scan pixel values in rows of a modified image and to store every 20th pixel value into a separate image file, thus forming a modified image representation, modified image representation e.g., 215A-215E, 315A-315B, that is 1/20 of the size of a modified image, e.g. modified image, e.g., 216A, 216B. In another example, forming a modified image representation may involve server 220 compressing a modified image in a manner that preserves fidelity of certain regions within a modified image, which may operate to preserve certain details of a modified image in areas of interest while compressing other regions of a modified image. In example embodiments, server 220 may execute a Python script or the like, which may access libraries and/or support tools, to generate modified image representations, such as modified image representations 215A-250E, 315A-315B.

Process 400 may continue at block 435, at which server 220 can transmit one or more modified image representations to computer workstation 212. In an example, transmission of modified image representations, e.g., 215A-250E, 315A-315B, may occur simultaneously with (or substantially simultaneously with) generation of a modified image, e.g., modified image 216A-216B. In example embodiments, server 220 may format modified image representations for transmission utilizing a JavaScript Object Notation (JSON), although, in other example embodiments, server 220 may format modified image representations using any other suitable format.

Process 400 may continue at block 440, at which computer workstation 212 may display, e.g. utilizing display 210, the one or more modified image representations, e.g., 215A-250E, 315A-315B, provided by the server 220 in the block 435. In response to a selection, at block 445, of the modified image representation, the process may continue at block 450. Block 450 may include server 220 storing a high-resolution modified image, e.g., 216A, 216B, such as an image comprising 12 megabytes, 24 megabytes, 50 megabytes, etc., in an image database, e.g., image database 230.

In response to an indication at block 445 that a modified image representation, e.g., modified image representation e.g., 215A-215E, 315A-315B, does not represent a modified image that is to be used for training a computer vision application, the process may continue at block 455, at which server 220 may discard any high-resolution modified image that have been generated based on signals transmitted by the user interface at block 525.

Process 400 may continue at block 460, which may include determining whether additional modified images are to be generated from base image 215. Responsive to an indication that additional modified images are to be generated utilizing a base image, e.g., base image 215, the process returns to block 420. Block 460 may include server 220 accessing a counter, which may be decremented from an initial value corresponding to the number of images selected via the user interface of FIG. 4. Thus, for example, responsive to a user selection to indicate that 100 modified images are to be returned from server 220, a counter may be decremented to a value of 99. In response to a counter indicating that no additional base images are to be modified, process 500 ends.

Thus, blocks 420-460 may form an inner loop that begins with a user interface displaying menu options for receiving selections indicating probabilities of one or more modification types are to be performed a base image, e.g., base image 215 (at block 420), receiving signals to indicate selection of modification parameters to be applied to a base image, e.g., tilt, rotation, horizontal flip, vertical flip, etc., to a base image (at block 425), transmitting modification probabilities or parameters to server 220 (at block 425), generating a modified and a modified image representation (at block 430), transmitting the modified image representation to, for example, computer workstation 212, (at block 435), displaying the modified image representation (at block 440), and determining whether the modified image representation is to be used for training a computer vision application (at block 445). Responsive to a determination that the modified image representation corresponds to a modified image that is useful for training purposes, the server may store a high-resolution modified image (at block 450) in a database. Responsive to a determination that the modified image representation indicates an image that is not to be used for training purposes, the image may be discarded (at block 455). In response to a determination that additional images are to be generated, (at block 460), which may involve decrementing a counter, the process returns to block 420. Responsive to an indication that no additional base images are to be modified, the process ends.

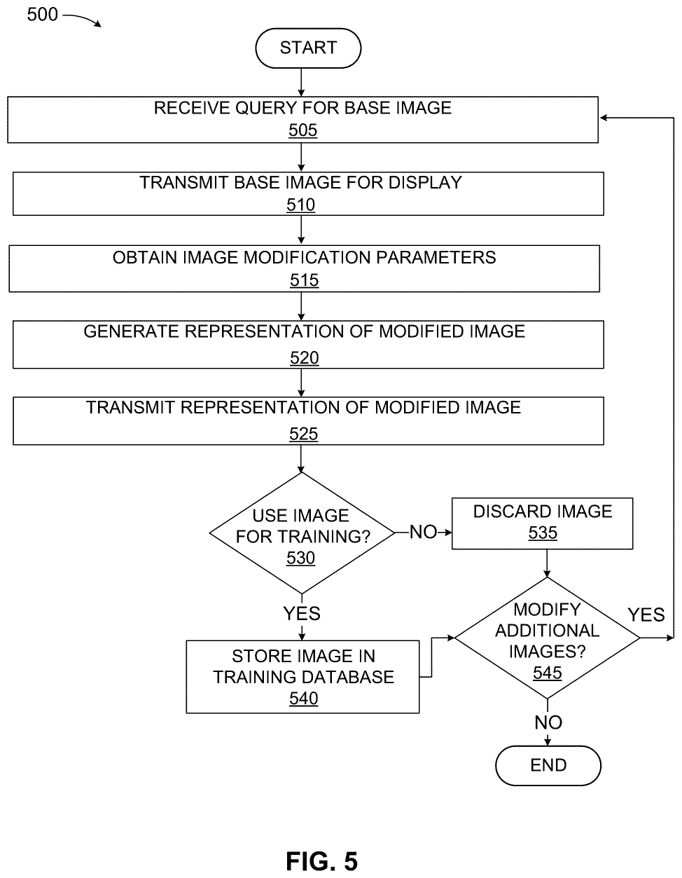

FIG. 5 is a flowchart diagram of an example process 500 for generating modified image representations, such as described in relation to FIGS. 2 and 3. Process 500 can be implemented utilizing computer workstation 212, cooperating with a second computer, e.g., server 220. A user may take part in a process to train a computer vision application utilizing a base image, e.g., 215, 315, and then applying various modification types via a user interface such as described in reference to FIG. 3, to the base image, such as tilting or rotating the base image, modifying contrast of the base image, modifying lighting conditions, introducing visual noise, etc. To modify a base image, e.g., 215, 315, the user can select parameters in the form of probabilities, which can indicate a percentage of returned, modified images that have undergone the user-selectable modifications described in reference to FIG. 3. Process 500 includes multiple blocks that can be executed in the illustrated order. Process 500 could alternatively or additionally include fewer blocks or can include the blocks executed in different orders.

Process 500 may begin at block 505, at which a user may transmit a query for reception by, for example, server 220. The transmitted query may include a request for a particular base image. For example, in a manufacturing environment, a query received by server 220 may comprise a query for a base image, e.g., base image 215, 315, that pertains to a particular component or assembly installed in the manufacturing environment. Alternatively, a query could refer to a general category of images.

Process 500 may continue at block 510, at which a server, e.g., server 220, transmits a base image, e.g., base image 215, 315, for display via a display device, such as display device 210 of computer workstation 212.

Process 500 may continue at block 515, at which a server, e.g., server 220, obtains parameters indicating the types of modifications that are to be performed to the base image along with, for example, probabilities of each type of modification as described in reference to FIG. 3. Obtained parameters may additionally include a number of images that are to be generated utilizing the modification parameters. Modification types to be performed to base image 215 may include tilting or rotation of the base image, modification contrast of areas within the base image, addition of visual blur to the base image, addition of noise to the base image, and so forth, as described in reference to FIG. 3.

Process 500 may continue at block 520, at which the server may generate a representation of a modified image for transmission to computer workstation 212. In example embodiments, generation of modified image representations, e.g., modified image representations 215A-215E, 315A-315B, may occur simultaneously, or substantially simultaneously, with server 220 generating high-resolution modified images. In example embodiments, a representation of, e.g., modified base image 215, may comprise a down-sampled representation of an image that has been modified in accordance with the image types of modifications, and the probability that a type of modification is to be present in a modified image, which are obtained at block 515. A modified image representation may include a version of an image that is 5% of the file size of the modified image, 10% of the file size of the modified image, etc. In example embodiments server 220, may apply an image compression technique to the modified image to form a modified image representation, which may preserve fidelity of a portion of a modified image while applying lossy compression to other portions of the modified image.

Process 500 may continue at block 525, at which the representation of the modified image is transmitted from a server, e.g., server 220, for display utilizing, for example, a display device coupled to computer workstation 212.

Process 500 may continue at block 530, at which a decision is made as to whether the representation of the image represents a modified image that is to be used for training, e.g., training a computer vision application. In response to a determination that the representation of the modified image does not represent an image that is to be used in training, e.g., a computer vision application, the image may be discarded at block 535, and the process may advance to block 545. In response to a determination that the representation of the modified image represents an image that is to be used in training, the process continues at block 540, at which the image may be stored in a training database or other type of repository that comprises a corpus of images.

At block 545, a decision may be made as to whether there are additional images for training of, for example, a computer vision application. Responsive to a determination that additional images are to be modified for training purposes, the process returns to block 505, at which a server, e.g., server 220, receives a query for an additional base image. Responsive to determining that no additional images are to be utilized for training, the process comes to an end.

Thus, in example embodiments, process 500 operates in a loop, in which a query is made for a base image (at block 505), a base image is transmitted for display (at block 510), image modification parameters are received (at block 515), a representation of a modified image is generated (at block 520), the representation is transmitted for display (at block 525). Responsive to a decision (at block 530) that the modified image representation indicates an image that is to be utilized for training a computer vision application, for example, the image is stored in a training database (at block 540). Responsive to a decision that the modified image representation indicates an image that is not to be utilized for training a computer vision application, for example, the image is discarded (at block 535). Responsive to a decision as to whether additional images are to be modified (at block 545) the method returns to block 505 until no more images are to be utilized for training the application.

### CONCLUSION

Computing devices such as those discussed herein generally each includes commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles, such as “a,” “the,” “said,” etc., should be read to recite one or more of the indicated elements unless a claim recites an explicit limitation to the contrary.

The term “exemplary” is used herein in the sense of signifying an example, i.e., a reference to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

What is claimed is:

1. A system comprising:
a first computer including a processor coupled to a memory, the memory including instructions executable by the processor to:
obtain user input of parameters to direct probabilities of modification types for a base image stored in a database;
generate, responsive to the user input, a representation of the base image that includes modifications according to the input parameters; and
transmit the representation of the base image to a second computer for display.

2. The system of claim 1, wherein the input parameters comprise directions to:
rotate the base image in a horizontal plane of the base image;
rotate the base image in a vertical plane of the base image;
modify contrast between portions of the base image;
modify brightness of a portion of the base image;
modify visual noise content of a portion of the base image; and/or
add blur to a portion of the base image.

3. The system of claim 1, wherein the representation of the modified base image corresponds to a down-sampled modified representation of the base image.

4. The system of claim 1, wherein the input parameters comprise a selection of a number of representations of the base image to be transmitted to the second computer for display.

5. The system of claim 1, wherein the representation of the modified base image corresponds to a down-sampled modified representation of the base image, wherein the modified representation is down-sampled by a user-selectable amount.

6. The system of claim 1, wherein the representation of the modified base image is to be transmitted in a JavaScript Object Notation (JSON) format.

7. The system of claim 1, wherein the modified base image comprises an array of red-green-blue (RGB) values.

8. The system of claim 1, wherein the representation of the modified base image corresponds to a down-sampled modified representation of the base image, and wherein the instructions executable by the processor further include instructions to:
obtain a down sampling value to be applied to the modified base image.

9. The system of claim 1, wherein transmission of the representation of the base image is substantially simultaneous with generation of the modified base image.

10. The system of claim 1, wherein the instructions further include instructions to:
transmit the base image from the first computer to the second computer prior to obtaining the input parameters.

11. A method comprising:
obtaining, from a first computer including a processor coupled to a memory, a user input of parameters for directing probabilities modification types for a base image stored in a database;
generating, responsive to the user input, a representation of the base image that includes modifications according to the input parameters; and
transmitting the representation of the base image to a second computer for display.

12. The method of claim 11, wherein the input parameters comprise a selectable number of representations of the base image to be transmitted to the second computer for display.

13. The method of claim 11, wherein the input parameters comprise directions to:
rotate the base image in a horizontal plane of the base image;
rotate the base image in a vertical plane of the base image;
modify contrast between portions of the base image;
modify brightness of a portion of the base image;
modify visual noise content of a portion of the base image; and/or
add blur to a portion of the base image.

14. The method of claim 11, wherein the representation of the modified base image corresponds to a down-sampled modified representation of the base image.

15. The method of claim 11, wherein the representation of the modified base image corresponds to a compressed modified representation of the base image.

16. The method of claim 11, further comprising:
obtaining a user input of a parameter indicating a down sampling amount of the representation of the modified base image.

17. The method of claim 11, wherein transmitting the representation of the base image is performed substantially simultaneously with generating the modified base image.

18. The method of claim 11, further comprising:
transmitting the base image from the first computer to the second computer prior to obtaining the input parameters.
